(19) United States
(12) Patent Application Publication
(10) Pub. No.: US 2007/0216653 A1
(43) Pub. Date: Sep. 20, 2007

(54) Pointing method and system for quickly moving an object to a designated area

(75) Inventor: Chi-Hung Chang, Taipei (TW)

Correspondence Address: Silicon Valley Patent Group LLP, 18805 Cox Avenue, Suite 220, Saratoga, CA, 95070, US

(73) Assignee: Lite-On Technology Corporation, Taipei (TW)

(21) Appl. No.: 11/713,433

(22) Filed: Mar. 2, 2007

(30) Foreign Application Priority Data
Mar. 17, 2006 (TW) 095109362

(51) Int. Cl. G06F 3/02

(52) U.S. Cl. 345/169

(57) ABSTRACT

A pointing method for a mobile communication device having a screen and a plurality of keys with respective key values for moving an object to a designated area of the screen is provided. The pointing method includes steps of (A) dividing the screen into a number of screen areas in accord with a number of the keys; (B) providing a coordinate of a specific point in each of the screen areas; (C) associating each of the key values with the respective coordinate; (D) sending a moving command through one of the plurality of keys; and (E) moving the object to the respective coordinate in response to the moving command.

### FIELD OF THE INVENTION

The present invention relates to a pointing method and system, and more particularly to a pointing method and system for quickly moving an object to a designated area in a display of a mobile communication device, which is not equipped with a touch screen.

### BACKGROUND OF THE INVENTION

As various electronic products continue to weed through the old and bring forth the new, the functions of the involved software system are getting complicated and the interactions between people and such electronic products are getting diverse. From the early keyboard for inputting character commands to input tools like mouse, light pen, rocker, digitizing tablet, touch keyboard and touch screen, cooperated with the emerging well-known menu system, the use of various software and hardware has already entered people's life. The interaction between people and electronic products which is “simple, natural, friendly, consistent” has become an important principle for the user interface design.

Guided by the trend, the human-machine interaction mode is continuously updating. Techniques like speech identification and synthesis, hand writing and gesture identification and virtual reality are all becoming interaction channels between people and electronic products, and their application scope is becoming broader and broader. The traditional computer, the personal digital assistant, and even the mobile communication device of the mobile phone and the popular mp3 player are all influenced by the human-machine interface. The influence of the design quality of the human-machine interface on the overall system effect becomes bigger and bigger. A well-designed human-machine interface not only can reduce the learning time and advance the time of developing system benefit at the early stage of using, but also can elevate the overall effect of the system and reduce the possibility of the system error after the learning stage.

Therefore, a well-designed human-machine interface is usually an important factor for consumer having the desire to purchase the product, and also one of the considerations of practicality, especially in the software application of the mobile phone. For example, in the feature phone and the smart phone without touch screens, at the hardware level they only provide the input interface like direction keys with up, down, left and right, numeric keys and execute keys for the user to operate, thus resulting in great inconvenience of use in software applications.

For instance, because nowadays the mobile phone usually has various multimedia functions, if one wants to add a heart-shaped pattern on the top left corner of the original picture in the editing software that can edit patterns of figures, the user can only keep pressing the up and left direction keys until the heart-shaped pattern reaches the desired position. This is inconvenient and time-consuming.

In conclusion, in light of the fact that there are still flaws when using the software of the current mobile communication device, the applicant proposes the present invention “pointing method and system for quickly moving an object to a designated area” to enhance the object pointing speed in the display and increase the smoothness of operation.

### SUMMARY OF THE INVENTION

In accordance with one aspect of the present invention, a pointing method for a mobile communication device having a screen and a plurality of keys with respective key values for moving an object to a designated area of the screen is provided. The pointing method includes steps of (A) dividing the screen into a number of screen areas in accord with a number of the keys; (B) providing a coordinate of a specific point in each of the screen areas; (C) associating each of the key values with the respective coordinate; (D) sending a moving command through one of the plurality of keys; and (E) moving the object to the respective coordinate in response to the moving command.

Preferably, the step (E) further comprises converting the moving command into one of the plurality of key values to obtain the respective coordinate.

Preferably, a position of each of the plurality of keys on the mobile communication device is corresponding to that of the respective coordinate on the screen.

Preferably, the plurality of keys are numeric keys from 1 to 9.

Preferably, the object is selected from a group consisting of a pattern, an icon and a cursor displayed on the mobile communication device.

Preferably, the display screen is an operation area where the object can be moved around.

Preferably, the mobile communication device is one of a feature mobile phone and a smart mobile phone.

Preferably, the feature mobile phone is a closed framework mobile phone having at least one specific function.

Preferably, the smart mobile phone is an open framework mobile phone having an open-end operation system.

In accordance with another aspect of the present invention, a pointing system for quickly moving an object to a designated area in a display screen is provided. The pointing system comprises a screen for displaying an object; a first module having a plurality of keys and sending out a moving command through a respective one of the plurality of keys; and a second module defining a plurality of points of the screen with a number thereof being in accord with that of the plurality of keys and moving the object to the respective point in response to the moving command.

Preferably, the second module is a control module further comprising a table and a processing unit, and each of the plurality points has a respective coordinate.

Preferably, the table comprises a plurality of key values and the coordinates of the plurality of points.

Preferably, the processing unit converts one of a plurality of key values to the respective coordinate in response to the moving command and moves the object to the respective coordinate.

Preferably, the screen has a plurality of screen areas with a number thereof being in accord with that of the plurality of keys, and the plurality of points are respectively defined on the respective plurality of screen areas.

Preferably, a position of each of the plurality of keys on the first module is corresponding to that of the respective coordinate on the display screen.

Preferably, the plurality of keys are numeric keys from 1 to 9.

Preferably, the object is selected from a group consisting of a pattern, an icon and a cursor.

In accordance with a further aspect of the present invention, a pointing method for a mobile communication device is provided. The pointing method includes steps of (A) providing a table having a plurality of key values and a respective coordinate thereof; (B) providing a plurality of keys; (C) sending a moving command through one of the plurality of keys; (D) obtaining a corresponding coordinate according to the specific key value resulting from the moving command; and (E) moving the object to the corresponding coordinate in the display screen.

Preferably, the moving points are respectively located in screen areas respectively divided according to a number of the keys on the display screen.

In accordance with further another aspect of the present invention, a pointing method for a mobile communication device having a screen and a plurality of keys is provided. The pointing method includes steps of dividing the screen into a number of screen areas in accord with that of the keys; sending a moving command through one of the plurality of keys; and moving the object to the respective screen area in response to the moving command.

Preferably, the method further includes steps of providing a coordinate of a specific point in each of the screen areas; providing a respective key value to each of the keys; associating each of the key values with the respective coordinate; and moving the object to the respective coordinate in response to the moving command.

The above aspects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic diagram showing the framework for a pointing method and system for quickly moving an object to a designated area according to a preferred embodiment of the present invention;

FIG. 2 is a flow chart of table setting according to a preferred embodiment of the present invention;

FIG. 3 is a flow chart of executing rapid movement of an object on the display screen according to a preferred embodiment of the present invention;

FIGS. 4(A) and 4(B) show the numeric keys and the corresponding moving points on the display, respectively; and

FIG. 5 shows the results presented by using the method and system for quickly moving an object to a designated area in the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

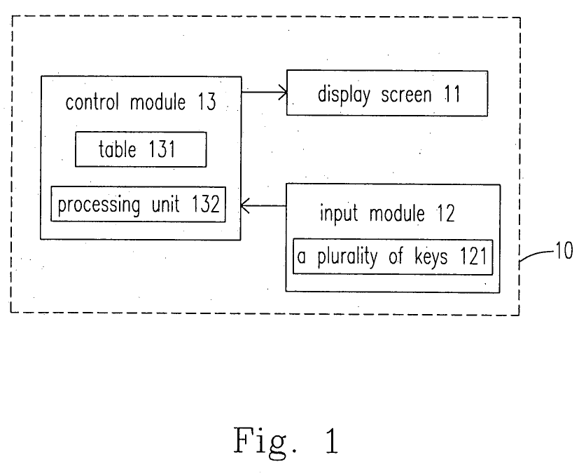

Please refer to FIG. 1, which is a schematic diagram showing the framework for a pointing method and system for quickly moving an object to a designated area according to a preferred embodiment of the present invention. The pointing system is applicable to a mobile communication device 10, which mainly includes a display screen 11, an input module 12 and a control module 13. The control module 13 is electrically connected to the display screen 11 and the input module 12 respectively. Therefore, the input command of the input module 12 can be processed by the control module 13, and the results are displayed on the display screen 11.

Besides, the input module 12 comprises a plurality of keys 121 for the user to click and the control module 13 comprises a table 131 and a processing unit 132, wherein the table 131 has a plurality of key values and corresponding coordinates, and thus when the user clicks one of the plurality of keys 121 to send out a moving command, the control module 13 receives the moving command and the processing unit 132 converts the moving command into a specific key value, and then the coordinate position of a corresponding moving point is obtained according to the table 131 and the object in the display screen 11 is moved to the coordinate position of the corresponding moving point.

Furthermore, the moving points are respectively located in the corresponding screen areas divided according to the number of the keys 121 on the display screen 11. The object is a pattern, an icon or a cursor displayed on the display screen 11. The mobile communication device is a feature phone or a smart phone, wherein the feature phone comprises at least a closed framework mobile phone having at least one specific function, and the smart phone comprises an open framework mobile phone having an open-end operation system.

Generally speaking, numeric keys from 1 to 9 are used as keys 121 that can execute rapid moving of the object, and thus the display screen 11 can be divided into 9 screen areas, and then the coordinate of one of the plurality of moving points in each screen area is defined to make the location of each key 121 on the input module 12 corresponding to the coordinate of the moving point on the display screen 11. Finally, these associated data are stored in the table 131. The concrete implementing steps will be described in detail as follows.

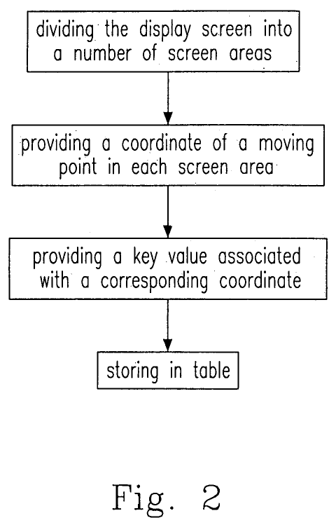

Please refer to FIG. 2, which is a flow chart of table setting according to a preferred embodiment of the present invention. Firstly, the display screen of the mobile communication device is divided into a number of screen areas in accord with the number of the keys for rapid moving. Then, a coordinate of a moving point in each screen area is provided, and a key value is associated with a corresponding coordinate. Finally, the information is stored in a table.

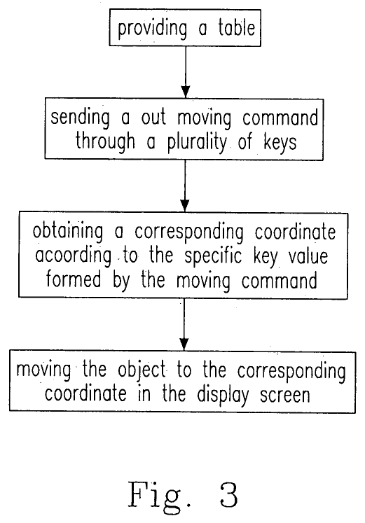

Please refer to FIG. 3, which is a flow chart of executing rapid movement of an object on the display screen according to a preferred embodiment of the present invention. Firstly, a table according to the storing method of FIG. 2 is provided. Since the table has a plurality of key values and each key value has its corresponding coordinate, when the user sends out a moving command through one of the keys, the corresponding coordinate position in the table can be obtained according to the key values formed by the moving command, and then the object in the display screen is rapidly moved to the corresponding coordinate position. Because the location of each key on the input module of the mobile communication device is corresponding to the coordinate position of the moving point in the display screen, when the key on the input module is pressed, the object will be moved to the corresponding position in the display screen.

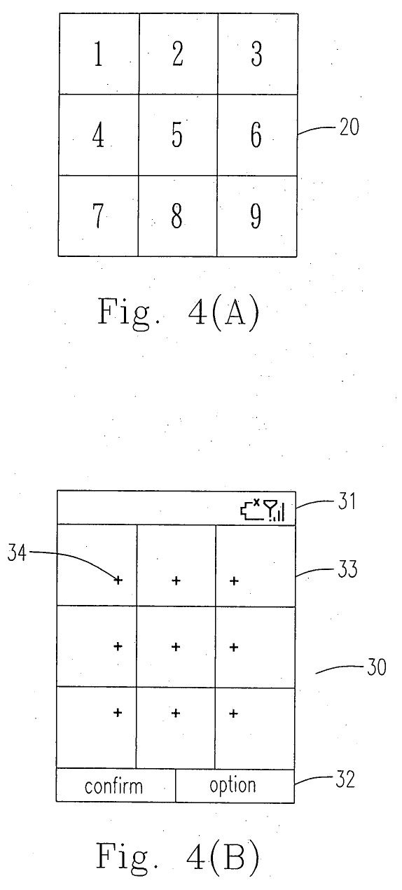

For practical implementation, please refer to FIGS. 4(A) and 4(B), wherein the numeric keys 20 from 1 to 9 are set to be the keys for the object of the display screen 30 for executing rapid moving. The display screen 30 can be divided into 9 areas and the moving points assigned by each area are respectively corresponding to keys 1 to 9 on the mobile phone.

Take an ordinary smart phone for example, the size of the display screen 30 includes about 176×220 pixels. If a Title Bar 31 and a Menu Bar 32 are excluded, the actual operation area 33 includes 176×180 pixels. Because human vision is usually focused in the middle area and a frame will be added, the following code will be obtained from setting the definitions for the respective key values of the nine numeric keys 20 and the move of each of the plurality of moving points 34 on the display screen 30:

//For patterns position
const POINT PATTERNS_KEY_1_POS={44, 45};
const POINT PATTERNS_KEY_2_POS={88, 45};
const POINT PATTERNS_KEY_3_POS={132, 45};
const POINT PATTERNS_KEY_4_POS={44, 90};
const POINT PATTERNS_KEY_5_POS={88, 90};
const POINT PATTERNS_KEY_6_POS={132, 90};
const POINT PATTERNS_KEY_7_POS={44, 135};
const POINT PATTERNS_KEY_8_POS={88, 135};
const POINT PATTERNS_KEY_9_POS={132, 135};

Thus, the relative position of each of the plurality of moving points 34 generated eventually is shown in FIG. 4(B).

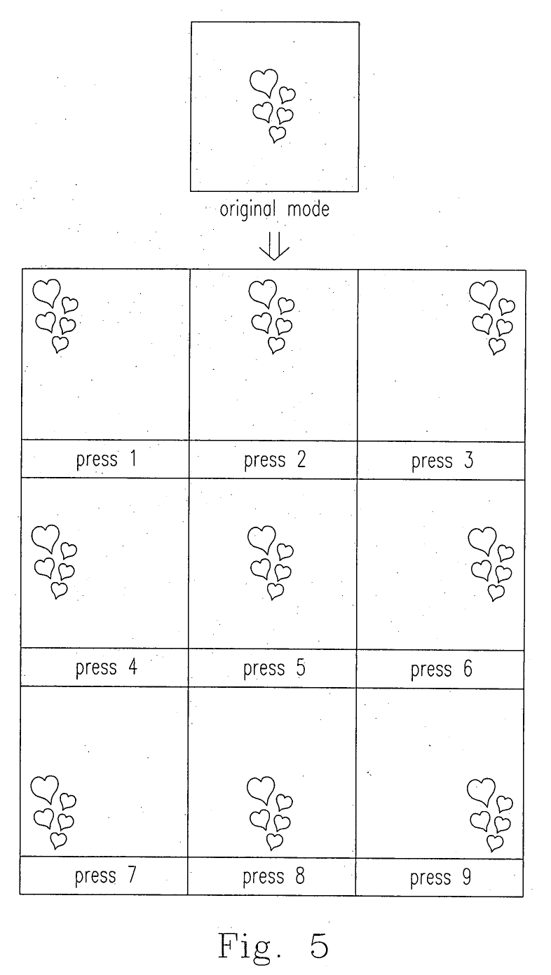

FIG. 5 is the actual screen displayed when using the technique of the present invention with keys 1 to 9 being pressed by the user. The heart-shaped pattern of the original mode is located at the center. Press 1 to move the heart-shaped pattern to the top left corner and press 9 to move it to the lower right corner, and then press the direction keys to adjust the direction of the pattern to rapidly and conveniently move it to the desired position.

In practical application, the technique of the present invention can arbitrarily assign the number of keys needed for rapid moving and set the corresponding coordinates respectively. The present invention provides a fast and convenient object oriented operation method, and thus a convenient and easy to use operation interface, through software technology. Therefore, the present invention can effectively solve the problem that in prior art the hardware doesn't provide good operation interface which makes the pattern editing process inconvenient, and also elevate the smoothness and applicability of the operation and increase the competitiveness of the mobile communication device of the present invention.

In conclusion, the present invention indeed can provide a pointing method and system for quickly moving an object to a designated area, which makes a break through in the subsistent minute and complicated way of pattern moving in the display screen. The present invention only employs simple software and uses keys as the input interface in the mobile communication device that does not equipped with a touch screen to quickly move an object to the corresponding position in the display screen. The present invention uses keys that are inherently disposed in the mobile communication device without changing the original device or adding new hardware structure, so the cost thereof is very low. The technique of the present invention is simple yet provides very high convenience, and has high degree of autonomy and also can effectively enhance industrial advancement. The technique of the present invention is simple and its applicable fields are broad. Therefore, the present invention effectively solves the problems and drawbacks in the prior art, and thus it fits the demand of the industry and is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A pointing method for a mobile communication device having a screen and a plurality of keys with respective key values for moving an object to a designated area of the screen, comprising steps of:
(A) dividing the screen into a number of screen areas in accord with a number of the keys;
(B) providing a coordinate of a specific point in each of the screen areas;
(C) associating each of the key values with the respective coordinate;
(D) sending a moving command through one of the plurality of keys; and
(E) moving the object to the respective coordinate in response to the moving command.

2. The method according to claim 1, wherein the step (E) further comprises converting the moving command into one of the plurality of key values to obtain the respective coordinate.

3. The method according to claim 1, wherein a position of each of the plurality of keys on the mobile communication device is corresponding to that of the respective coordinate on the screen.

4. The method according to claim 1, wherein the plurality of keys are numeric keys from 1 to 9.

5. The method according to claim 1, wherein the object is selected from a group consisting of a pattern, an icon and a cursor displayed on the mobile communication device.

6. The method according to claim 1, wherein the display screen is an operation area where the object can be moved around.

7. The method according to claim 1, wherein the mobile communication device is one of a feature mobile phone and a smart mobile phone.

8. The method according to claim 7, wherein the feature mobile phone is a closed framework mobile phone having at least one specific function.

9. The method according to claim 7, wherein the smart mobile phone is an open framework mobile phone having an open-end operation system.

10. A pointing system for quickly moving an object to a designated area in a display screen, comprising:
a screen for displaying an object;
a first module having a plurality of keys and sending out a moving command through a respective one of the plurality of keys; and
a second module defining a plurality of points of the screen with a number thereof being in accord with that of the plurality of keys and moving the object to the respective point in response to the moving command.

11. The system according to claim 10, wherein the second module is a control module further comprising a table and a processing unit, and each of the plurality points has a respective coordinate.

12. The system according to claim 11, wherein the table comprises a plurality of key values and the coordinates of the plurality of points.

13. The system according to claim 12, wherein the processing unit converts one of a plurality of key values to the respective coordinate in response to the moving command and moves the object to the respective coordinate.

14. The system according to claim 10, wherein the screen has a plurality of screen areas with a number thereof being in accord with that of the plurality of keys, and the plurality of points are respectively defined on the respective plurality of screen areas.

15. The system according to claim 10, wherein a position of each of the plurality of keys on the first module is corresponding to that of the respective coordinate on the display screen.

16. The system according to claim 10, wherein the plurality of keys are numeric keys from 1 to 9.

17. The system according to claim 10, wherein the object is selected from a group consisting of a pattern, an icon and a cursor.

18. A pointing method for a mobile communication device, comprising steps of:
(A) providing a table having a plurality of key values and a respective coordinate thereof;
(B) providing a plurality of keys;
(C) sending a moving command through one of the plurality of keys;
(D) obtaining a corresponding coordinate according to the specific key value resulting from the moving command; and
(E) moving the object to the corresponding coordinate in the display screen.

19. The method according to claim 18, wherein the moving points are respectively located in screen areas respectively divided according to a number of the keys on the display screen.

20. A pointing method for a mobile communication device having a screen and a plurality of keys for:
dividing the screen into a number of screen areas in accord with that of the keys;
sending a moving command through one of the plurality of keys; and
moving the object to the respective screen area in response to the moving command.

21. The method according to claim 20, further comprising steps of:
providing a coordinate of a specific point in each of the screen areas;
providing a respective key value to each of the keys;
associating each of the key values with the respective coordinate; and
moving the object to the respective coordinate in response to the moving command.
